(19) United States
(12) Patent Application Publication
(10) Pub. No.: US 2013/0162401 A1
(43) Pub. Date: Jun. 27, 2013

(54) APPARATUS AND METHOD FOR TRANSMITTING TAG DATA

(71) Applicants: Ji-Hoon Bae, Daejeon (KR); Chan-Won Park, Daejeon (KR); Hyung Chul Park, Seoul (KR); Jong-Suk Chae, Daejeon (KR); Cheol Sig Pyo, Daejeon (KR)

(72) Inventors: Ji-Hoon Bae, Daejeon (KR); Chan-Won Park, Daejeon (KR); Hyung Chul Park, Seoul (KR); Jong-Suk Chae, Daejeon (KR); Cheol Sig Pyo, Daejeon (KR)

(73) Assignees: SEOUL NATIONAL UNIVERSITY OF SCIENCE & TECHNOLOGY, FOUNDATION FOR RESEARCH & BUSINESS, Seoul (KR); ELECTRONICS AND TELECOMMUNICATIONS RESEARCH INSTITUTE, Daejeon (KR)

(21) Appl. No.: 13/614,331

(22) Filed: Sep. 13, 2012

(30) Foreign Application Priority Data
Dec. 27, 2011 (KR) 10-2011-0143940

(51) Int. Cl. G06K 7/01

(52) U.S. Cl. 340/10.1

(57) ABSTRACT

A tag transmitting apparatus of a passive RFID system generates a plurality of orthogonal square waves, converts tag data to a plurality of parallel data, and transmits the plurality of parallel data to a reader using a plurality of square waves as a subcarrier.

### CROSS-REFERENCE TO RELATED APPLICATION

This application claims priority to and the benefit of Korean Patent Application No. 10-2011-0143940 filed in the Korean Intellectual Property Office on Dec. 27, 2011, the entire contents of which are incorporated herein by reference.

### BACKGROUND OF THE INVENTION

(a) Field of the Invention

The present invention relates to a method and apparatus for transmitting tag data. More particularly, the present invention relates to a method and apparatus for transmitting tag data from a tag of a passive radio frequency identification (RFID) system.

(b) Description of the Related Art

RFID is technology that recognizes an electronic tag that is attached to a product using a radio frequency with non-contact automatic recognition technology.

RFID technology is classified into a passive RFID system and an active RFID system according to whether power is supplied to a tag. In the passive RFID system, a tag generates its own power with a carrier signal that is transmitted from a reader instead of receiving power from a battery, and performs communication with the reader based on backscatter.

Such a passive RFID system can provide information of an individual product and can thus have application factors such as a long recognition distance and simultaneous recognition of a large number of tags, and reading and writing information from and to a tag memory, compared with a barcode. However, the passive RFID system has a problem in bandwidth efficiency. The tag of the passive RFID system uses a single subcarrier-based transmission method. However, because the tag of the passive RFID system uses a method of absorbing or reflecting a carrier signal that is transmitted from the reader by changing antenna impedance, a signal that is transmitted from the tag has a form of a square wave. In this case, because it is difficult to set antenna impedance to a random value, the antenna impedance is mostly set to two cases of 50 ohms and an open state. Therefore, for transmission information of the tag, it is almost impossible to use a pulse shaping filter. Because fast Fourier transform (FFT) of a square wave is represented with a sinc function, there is a problem that an occupation bandwidth is much larger than that of a signal that uses a pulse shaping filter.

### SUMMARY OF THE INVENTION

The present invention has been made in an effort to provide a method and apparatus for transmitting tag data having advantages of improving bandwidth efficiency in a passive RFID system.

An exemplary embodiment of the present invention provides a method of transmitting tag data from a tag of a passive radio frequency identification (RFID) system. The method includes converting tag data that are input in series to a plurality of parallel data, generating a plurality of square waves, and transmitting the plurality of parallel data using the plurality of square waves as a subcarrier.

The plurality of square waves may be mutually orthogonal.

The transmitting of the plurality of parallel data may include modulating the plurality of square waves using a load modulation, respectively.

The transmitting of the plurality of parallel data may further include transmitting the plurality of square waves in which a load is modulated through a plurality of tag antennas.

A frequency of the plurality of square waves may not include a harmonic frequency between subcarriers.

Another embodiment of the present invention provides an apparatus that transmits tag data of a passive RFID system. The apparatus includes a demultiplexer, a plurality of square wave generators, a plurality of multipliers, and a plurality of load modulation units. The demultiplexer converts serial data including tag data to a plurality of parallel data. The plurality of square wave generators generate each of a plurality of square waves to use as a subcarrier. The plurality of multipliers multiply and output the plurality of parallel data to the plurality of square waves, respectively. The plurality of load modulation units modulate signals of the plurality of square waves using a load modulation, respectively and transmit a plurality of load modulated signals.

Frequencies of the plurality of subcarriers may be mutually orthogonal.

The frequency of the plurality of subcarriers may not include a harmonic frequency between subcarriers.

The apparatus may further include a plurality of tag antennas that output the plurality of load modulated signals.

### BRIEF DESCRIPTION OF THE DRAWINGS

FIG. 1 is a graph illustrating a spectrum of a tag transmitting signal in a general passive RFID system.

FIG. 2 is a block diagram illustrating a configuration of a tag transmitting apparatus of a passive RFID system according to an exemplary embodiment of the present invention.

FIG. 3 is a flowchart illustrating a method of transmitting a tag of a passive RFID system according to an exemplary embodiment of the present invention.

FIG. 4 is a diagram illustrating an example of a load modulation method of a load modulation unit according to an exemplary embodiment of the present invention.

FIG. 5 is a block diagram illustrating a configuration of a reader receiving apparatus of a passive RFID system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for transmitting tag data according to an exemplary embodiment of the present invention will be described in detail with reference to the drawings.

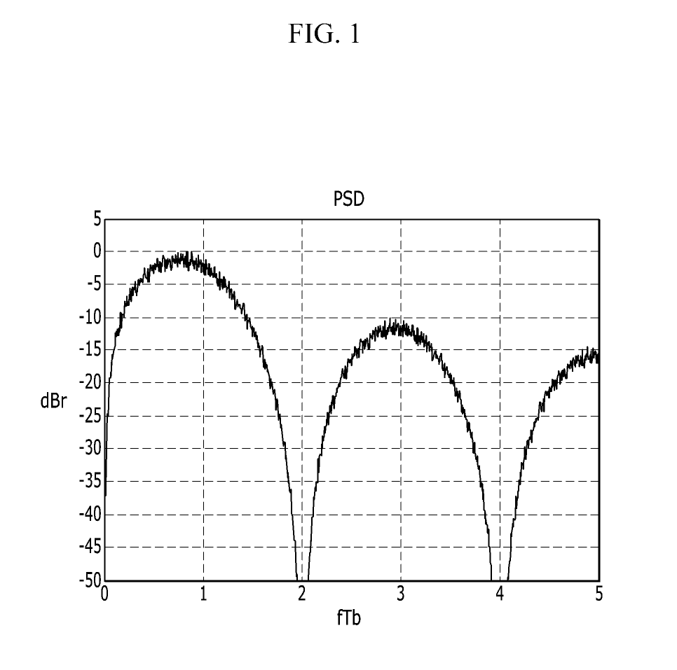

FIG. 1 is a graph illustrating a spectrum of a tag transmitting signal in a general passive RFID system, and illustrates a spectrum of a tag transmitting signal of a frequency modulation 0 (FMO) encoding method in an International Standardization Organization (ISO) 18000-6 C standard.

In FIG. 1, the x-axis represents a frequency that is normalized with a data rate. Therefore, in the x-axis, 1 is the data rate.

As shown in FIG. 1, even in a frequency band fTb=5 in which a data rate becomes five times, a signal component that is attenuated to only 15 dB, compared with a highest value of a spectrum, is illustrated. This is because a tag signal that transmits from the tag uses a signal having a form of a square wave. A signal of a square wave form cannot be changed due to tag characteristics of such a passive RFID system, but by using a multiple subcarrier instead of a single subcarrier, bandwidth efficiency can be improved.

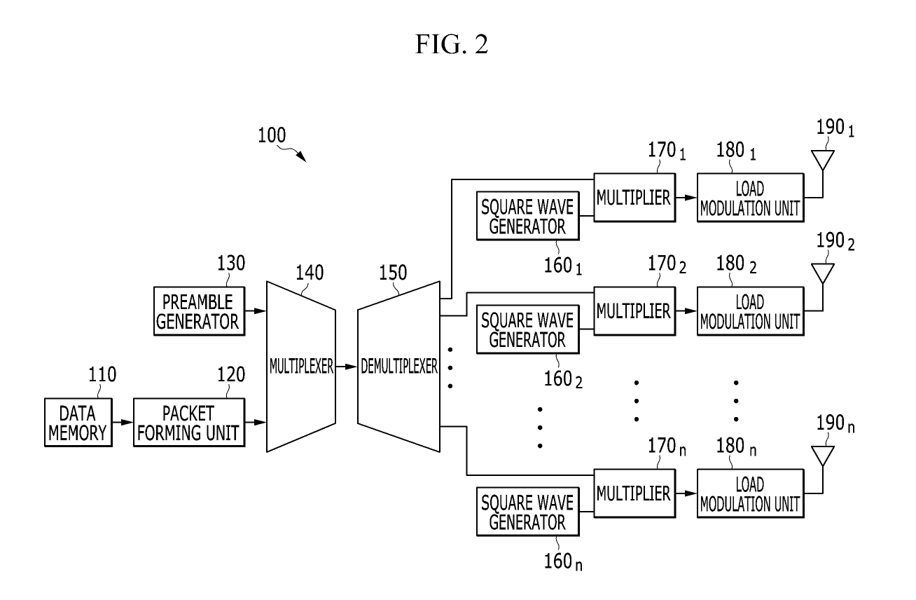

Hereinafter, a passive RFID system that can improve a bandwidth using a multiple subcarrier will be described in detail with reference to FIGS. 2 to 5.

FIG. 2 is a block diagram illustrating a configuration of a tag transmitting apparatus of a passive RFID system according to an exemplary embodiment of the present invention.

Referring to FIG. 2, a tag transmitting apparatus 100 of a passive RFID system includes a data memory 110, a packet forming unit 120, a preamble generator 130, a multiplexer 140, a demultiplexer 150, a plurality of square wave generators 160₁-160ₙ, a plurality of multipliers 170₁-170ₙ, a plurality of load modulation units 180₁-180ₙ, and a plurality of tag antennas 190₁-190ₙ.

At the data memory 110, tag data, for example, an identifier of a tag and data of a product in which a tag is to be attached, are stored.

The packet forming unit 120 outputs tag data that are stored at the data memory 110 to the multiplexer 140. The tag data include an identifier of a tag and information of an object to which the tag is attached.

The preamble generator 130 generates a preamble representing the start of a packet and transfers the preamble to the multiplexer 140. Such a preamble may be used for identifying a protocol message. That is, it may be determined whether a response message is a response message from a tag to a reader through a preamble.

The multiplexer 140 converts a preamble and tag data to one serial data and outputs the serial data.

The demultiplexer 150 converts the serial data to a plurality of parallel data and outputs the plurality of parallel data. That is, a preamble and tag data that are added by the multiplexer 140 are separated to parallel data in the demultiplexer 150. Thereby, a plurality of data may be transmitted at one time in a parallel form.

The square wave generators 160₁-160ₙ each generate a square wave of a predetermined frequency and output the square wave to corresponding multipliers 170₁-170ₙ.

In general, a subcarrier that is used for inverse fast Fourier transform (IFFT) of an orthogonal frequency division multiplexing (OFDM) transmitter is a sine wave in which each subcarrier has only a single frequency component. Because it is difficult for a tag of a passive RFID system to transmit a sine wave, the square wave generators 160₁-160ₙ generate a square wave and use the square wave as a subcarrier.

A subcarrier of a square wave is different in a configuration of a frequency from a subcarrier that is used for IFFT of an OFDM transmitter. In the IFFT of the OFDM transmitter, a frequency corresponding to all natural number times between 1 time and K times of a fundamental frequency, which is a data rate of each channel, is used. However, in the square wave, a harmonic wave component is included in a frequency to be odd-number times of a fundamental frequency. Therefore, a harmonic frequency that is generated by another subcarrier is not used as a frequency of a square wave that is used as a subcarrier, and a frequency having orthogonality between used subcarriers is used.

Table 1 shows a harmonic component that is generated in a subcarrier to be constant times of the data rate when the data rate is normalized as 1.

TABLE 1

| Subcarrier | |
|---|---|
| frequency | Harmonic frequency generated |
| (data rate = 1) | by subcarrier |
| 1 | 3, 5, 7, . . . , (2*k + 1) |
| 2 | 6, 10, 14, . . . , 2*(2*k + 1) |
| 3 | 9, 15, 21, . . . , 3*(2*k + 1) |
| 4 | 12, 20, 28, . . . , 4*(2*k + 1) |

.
.
.

| | |
|---|---|
| m | M*3, M*5, m*7, . . . , m*(2*k + 1) |

A combination of available subcarrier frequencies may be very various based on analysis of Table 1. Table 2 is a diagram illustrating an example of available subcarrier frequencies based on analysis of Table 1. Table 2 illustrates only a subcarrier frequency of a data rate of up to 16 times.

TABLE 2

| Excluded subcarrier | |
|---|---|
| frequency | Combination of available subcarrier |
| (data rate = 1) | frequencies |
| 0 | 1, 2, 4, 8, 11, 13, 16 |
| 1 | 2, 3, 4, 5, 7, 8, 11, 13, 16 |
| 1, 2 | 3, 4, 5, 6, 7, 8, 10, 11, 13, 14, 16 |
| 1, 2, 3 | 4, 5, 6, 7, 8, 9, 10, 11, 13, 14, 15, 16 |

Referring to Table 2, when an excluded subcarrier frequency has only a DC component (excluding subcarrier frequency=0), available subcarriers among 16 subcarrier frequencies become 7 (1, 2, 4, 8, 11, 13, and 16) and a user ratio becomes about 44%. However, when a subcarrier frequency, which is (data ratio*1) is excluded, a use ratio of available subcarriers becomes about 56%, when a subcarrier frequency, which is (data ratio*1) and (data ratio*2) is excluded, a use ratio of available subcarriers becomes about 69%, and when a subcarrier frequency, which is (data ratio*1), (data ratio*2), and (data ratio*3) is excluded, a use ratio of available subcarriers becomes about 75%.

Square waves are set to the square wave generators 160₁-160ₙ with different frequencies among such available subcarriers. For example, when a subcarrier frequency, which is (data ratio*1), (data ratio*2), and (data ratio*3) is excluded, different frequencies among “4, 5, 6, 7, 8, 9, 10, 11, 13, 14, 15, and 16” are set to the square wave generators 160₁-160ₙ. Therefore, square waves that are generated by the square wave generators 160₁-160ₙ maintain orthogonality.

Next, the multipliers 170₁-170ₙ multiply parallel data that are input by the demultiplexer 150 to a subcarrier of a corresponding square wave and output the parallel data to the load modulation units 1801-180n, respectively.

The load modulation units 180₁-180ₙ modulate subcarriers to which the parallel data are multiplied using a load modulation and output load modulated subcarriers through the tag antennas 190₁-190ₙ, respectively.

The tag antennas 190₁-190ₙ output signals of the load modulated subcarriers by the load modulation units 180₁-180ₙ, respectively.

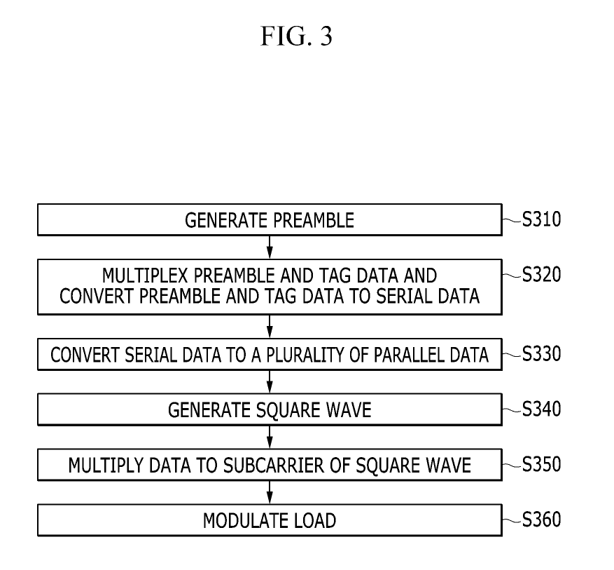

FIG. 3 is a flowchart illustrating a method of transmitting tag data according to an exemplary embodiment of the present invention.

Referring to FIG. 3, the preamble generator 130 generates a preamble representing the start of a packet and outputs the preamble to the multiplexer 140 (S310).

Thereafter, the multiplexer 140 multiplexes the preamble and tag data and converts the multiplexed preamble and tag data to one serial data (S320), and the demultiplexer 150 converts the serial data to a plurality of parallel data (S330).

The square wave generators 160₁-160ₙ each generate a square wave of a predetermined frequency (S340). As described above, a plurality of square waves that are generated by the square wave generators 160₁-160ₙ have mutual orthogonality.

The multipliers 170₁-170ₙ each multiply and output corresponding parallel data to a subcarrier of a corresponding square wave (S350).

The load modulation units 180₁-180ₙ modulate subcarriers in which parallel data are multiplied using a load modulation and output load modulated subcarriers through the tag antennas 190₁-190ₙ, respectively (S360).

In this way, the tag divides tag data into several subcarriers that are mutually orthogonal and having orthogonality like an OFDM method by using a square wave of a frequency, except for a harmonic frequency between subcarriers as a subcarrier, thereby transmitting the tag data without interference. Therefore, bandwidth efficiency can be improved, compared with a single subcarrier-based transmission method of an existing passive RFID system.

For example, it is assumed that a tag transmitting apparatus transmits tag data at A kbps. In this case, in an existing tag transmitting apparatus using a single carrier, in a spectrum of FIG. 1, a frequency between nulls becomes 2A KHz. However, according to an exemplary embodiment of the present invention, when the tag transmitting apparatus 100 divides tag data into several subcarriers having orthogonality and transmits the several subcarriers like an OFDM method, a signal spectrum distribution existing at the outside of a signal bandwidth can be reduced and thus the tag transmitting apparatus 100 according to an exemplary embodiment of the present invention can improve bandwidth efficiency more than that of an existing tag transmitting apparatus.

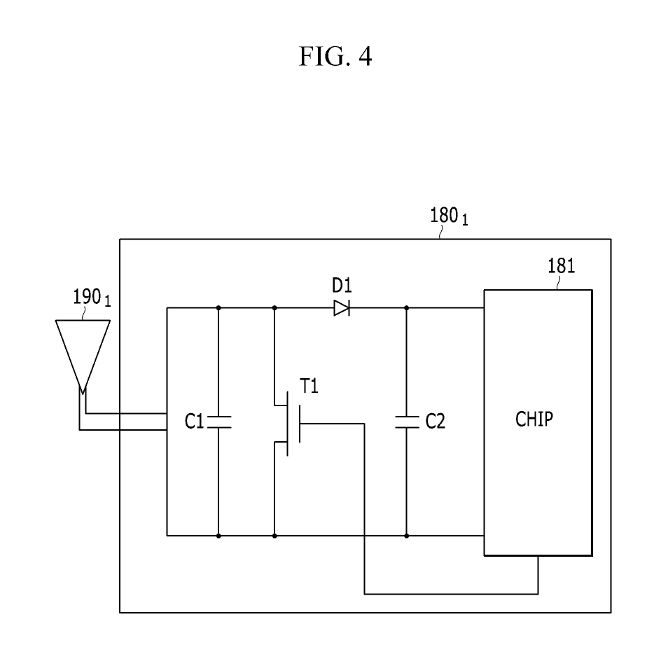

FIG. 4 is a diagram illustrating an example of a load modulation method of a load modulation unit according to an exemplary embodiment of the present invention.

Referring to FIG. 4, the load modulation unit 180₁ uses a backscatter modulation method, and for this purpose, the load modulation unit 180₁ includes capacitors C1 and C2, a diode D1, a transistor T1, and a chip 181.

The capacitor C1 is connected to both ends of the tag antenna 190₁, an anode of the diode D1 is connected to the tag antenna 190₁, and a cathode of the diode D1 is connected to the chip 181. In the transistor T1, a control terminal is connected to the chip 181, and a first terminal and a second terminal are connected to both ends of the tag antenna 190₁.

The diode D1 and the capacitor C2 rectify an RF signal that is received from the tag and extract a DC voltage. That is, an RF signal is converted to a DC voltage through a half-wave rectifier that is formed with the diode D1 and the capacitor C2, and is supplied to the chip 181.

The chip 181 receives a DC voltage as driving power to be activated, and the chip 181 changes capacitance of the capacitor C1, i.e., a capacitance load, by turning the transistor T1 that is connected to both ends of the tag antenna 190₁ on/off according to data to transmit, thereby transmitting tag data to a reader.

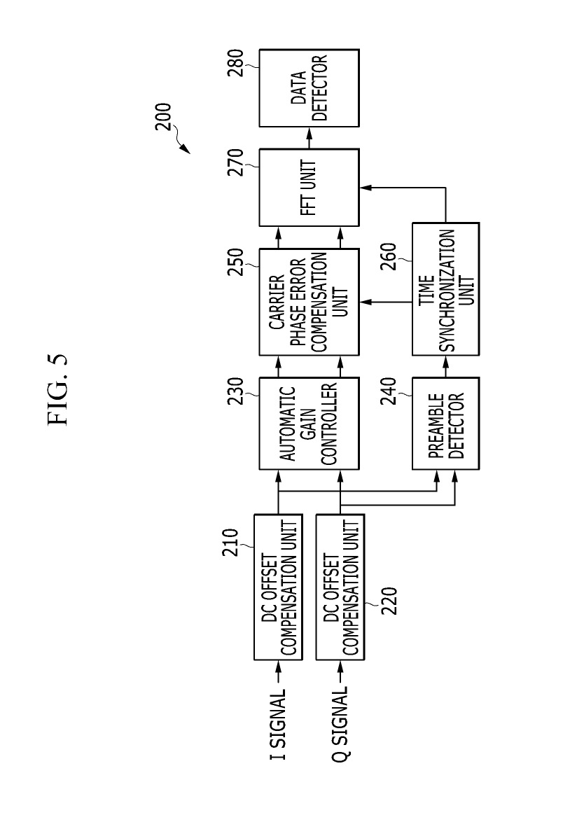

FIG. 5 is a block diagram illustrating a configuration of a reader receiving apparatus of a passive RFID system according to an exemplary embodiment of the present invention.

Referring to FIG. 5, a reader receiving apparatus 200 includes a DC offset compensation unit 210, a DC offset compensation unit 220, an automatic gain controller 230, a preamble detector 240, a carrier phase error compensation unit 250, a time synchronization unit 260, a fast Fourier transform unit (hereinafter referred to as an “FFT unit”) 270, and a data detector 280.

A subcarrier signal that is received through a reader antenna is converted to in-phase (I) and quadrature-phase (Q) signals of a baseband through a mixer (not shown). The mixer uses a reference frequency that is generated in a local oscillator. Particularly, a DC offset largely occurs in a direct conversion receiver (DCR) structure. In the DCR, a center frequency of a received signal and a frequency of a local oscillator signal that is input to the mixer are the same. In a process of mixing through the mixer, because of circuit characteristics of the mixer, self mixing occurs and thus a DC offset occurs.

The DC offset compensation unit 210 obtains a DC offset from an I signal of a received signal, compensates the DC offset, and outputs the I signal to the automatic gain controller 230.

The DC offset compensation unit 220 obtains a DC offset from a Q signal of a received signal, compensates the DC offset, and outputs the Q signal to the automatic gain controller 230.

The automatic gain controller 230 adjusts a gain of I and Q signals in which a DC offset is compensated, and outputs the I and Q signals to the carrier phase error compensation unit 250.

The preamble detector 240 detects a preamble from I and Q signals in which a DC offset is compensated, and outputs the preamble to the carrier phase error compensation unit 250 and the FFT unit 270.

The carrier phase error compensation unit 250 detects a phase error using a preamble from the I and Q signals in which an automatic gain is adjusted, to compensates a phase error of the I and Q signals, and outputs the I and Q signals to the FFT unit 270.

The time synchronization unit 260 detects a start point of a frame and a start position of FFT using a preamble and I and Q signals in which an automatic gain is adjusted.

The FFT unit 270 inputs I and Q signals in which an automatic gain is adjusted and performs FFT at a start position of FFT, thereby converting and outputting the I and Q signals to a signal of a frequency area. That is, the I and Q signals in which an automatic gain is adjusted are separated to a signal of each subcarrier band through FFT.

The data detector 280 detects tag data from a signal that is separated to each subcarrier band through the FFT unit 270.

In this way, in a tag of a passive RFID system according to an exemplary embodiment of the present invention, by transmitting tag data using subcarriers of mutually orthogonal square waves, a structure of the reader receiving apparatus 200 that receives a tag signal may be similar to a structure of an OFDM receiver. However, in an OFDM system, because an error occurs between a carrier frequency of an OFDM transmitter and a reference frequency that is generated in a local oscillator of an OFDM receiver, when a frequency error is compensated, degradation of receiving performance can be prevented. However, because a passive RFID system uses a carrier that is transmitted from a reader as a carrier for transmitting a tag signal, an error does not occur between a carrier frequency of the tag and a reference frequency of the reader. Therefore, the reader receiving apparatus 200 does not require a block for compensating a frequency error, unlike an OFDM receiver, and a carrier frequency thereof corresponds to a reference frequency of the reader and thus receiving performance can be improved.

According to an exemplary embodiment of the present invention, unlike an existing passive RFID system, by modulating a tag transmitting signal using a multiple antenna and a multiple load modulation unit, bandwidth efficiency can be improved, compared with the existing passive RFID system. Therefore, a plurality of RFID tags and readers can be used in a system that simultaneously requests information exchange.

An exemplary embodiment of the present invention may not only be embodied through the above-described apparatus and/or method, but may also embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting tag data from a tag of a passive radio frequency identification (RFID) system, the method comprising:
converting tag data that are input in series to a plurality of parallel data;
generating a plurality of square waves; and
transmitting the plurality of parallel data using the plurality of square waves as a subcarrier.

2. The method of claim 1, wherein the plurality of square waves are mutually orthogonal.

3. The method of claim 1, wherein the transmitting of the plurality of parallel data comprises modulating the plurality of square waves using a load modulation, respectively.

4. The method of claim 3, wherein the modulating of the plurality of square waves comprises modulating the plurality of square waves with a backscatter modulation method.

5. The method of claim 3, wherein the transmitting of the plurality of parallel data further comprises transmitting the plurality of square waves in which a load is modulated through a plurality of tag antennas.

6. The method of claim 1, wherein a frequency of the plurality of square waves does not comprise a harmonic frequency between subcarriers.

7. An apparatus that transmits tag data of a passive RFID system, the apparatus comprising:
a demultiplexer that converts serial data comprising tag data to a plurality of parallel data;
a plurality of square wave generators that generate each of a plurality of square waves to use as a subcarrier;
a plurality of multipliers that multiply and output the plurality of parallel data to the plurality of square waves, respectively; and
a plurality of load modulation units that modulate signals of the plurality of square waves using a load modulation, respectively and that transmit a plurality of load modulated signals.

8. The apparatus of claim 7, wherein frequencies of the plurality of subcarriers are mutually orthogonal.

9. The apparatus of claim 8, wherein the frequency of the plurality of subcarriers does not comprise a harmonic frequency between subcarriers.

10. The apparatus of claim 7, further comprising a plurality of tag antennas that output the plurality of load modulated signals, respectively.

11. The apparatus of claim 7, wherein the plurality of load modulation units use a backscatter modulation method.

12. The apparatus of claim 7, further comprising:
a preamble generator that generates a preamble representing the start of a packet; and
a multiplexer that converts the tag data and the preamble to the serial data and that outputs the serial data to the demultiplexer.
